(19) United States
(12) Patent Application Publication
(10) Pub. No.: US 2018/0304405 A1
(43) Pub. Date: Oct. 25, 2018

(54) LASER SPOT WELDING OF OVERLAPPING ALUMINUM WORKPIECES

(71) Applicant: GM GLOBAL TECHNOLOGY OPERATIONS LLC, Detroit, MI (US)

(72) Inventors: David S. Yang, Shanghai (CN); Jing Zhang, Shanghai (CN); Wu Tao, Tianmen (CN); Justin A. Wolsker, Shelby Township, MI (US)

(21) Appl. No.: 15/767,080

(22) PCT Filed: Nov. 6, 2015
(86) PCT No.: PCT/CN2015/094003

§ 371 Date: Apr. 9, 2018

(51) Int. Cl. B23K 26/22; B23K 26/082; B23K 26/32

(52) U.S. Cl. CPC B23K 26/22; B23K 2203/10; B23K 26/32; B23K 26/082

(57) ABSTRACT

A method of laser welding a workpiece stack-up (10) that includes at least two overlapping aluminum workpieces (12, 14) comprises advancing a laser beam (24) relative to a plane of a top surface (20) of the workpiece stack-up (10) and along a spot weld travel pattern (74) that includes one or more nonlinear inner weld paths and an outer peripheral weld path that surrounds the one or more nonlinear inner weld paths. Such advancement of the laser beam (24) along the spot weld travel pattern (74) translates a keyhole (78) and a surrounding molten aluminum weld pool (76) along a corresponding route relative to the top surface (20) of the workpiece stack-up (10). Advancing the laser beam (24) along the spot weld travel pattern (74) forms a weld joint (72), which includes resolidified composite aluminum workpiece material derived from each of the aluminum workpieces (12, 14) penetrated by the surrounding molten aluminum weld pool (76), that fusion welds the aluminum workpieces (12, 14) together.

### TECHNICAL FIELD

The technical field of this disclosure relates generally to laser welding and, more particularly, to a method of laser spot welding together two or more overlapping aluminum workpieces.

### BACKGROUND

Laser spot welding is a metal joining process in which a laser beam is directed at a metal workpiece stack-up to provide a concentrated energy source capable of effectuating a weld joint between the overlapping constituent metal workpieces. In general, two or more metal workpieces are first aligned and stacked relative to one another such that their faying surfaces overlap and confront to establish a faying interface (or faying interfaces) within an intended weld site. A laser beam is then directed at a top surface of the workpiece stack-up. The heat generated from the absorption of energy from the laser beam initiates melting of the metal workpieces and establishes a molten weld pool within the workpiece stack-up. The molten weld pool penetrates through the metal workpiece impinged upon by the laser beam and into the underlying metal workpiece or workpieces to a depth that intersects each of the established faying interfaces. And, if the power density of the laser beam is high enough, a keyhole is produced directly underneath the laser beam and is surrounded by the molten weld pool. A keyhole is a column of vaporized metal derived from the metal workpieces within the workpiece stack-up that may include plasma.

The laser beam creates the molten weld pool in very short order—typically milliseconds—once it impinges the top surface of the workpiece stack-up. After the molten weld pool is formed and stable, the laser beam is advanced along the top surface of the workpiece stack-up while tracking a predetermined weld path, which has conventionally involved moving the laser beam in a straight line or along a slightly-curved path such as a “C-shaped” path. Such advancement of the laser beam translates the molten weld pool along a corresponding route relative to top surface of the workpiece stack-up and leaves behind a trail of molten workpiece material in the wake of the advancing weld pool. This penetrating molten workpiece material cools and solidifies to form a weld joint comprised of resolidified composite workpiece material. The resultant weld joint fusion welds the overlapping workpieces together.

The automotive industry is interested in using laser welding to manufacture parts that can be installed on a vehicle. In one example, a vehicle door body may be fabricated from an inner door panel and an outer door panel that are joined together by a plurality of laser welds. The inner and outer door panels are first stacked relative to each other and secured in place by clamps. A laser beam is then sequentially directed at multiple weld sites around the stacked panels in accordance with a programmed sequence to form the plurality of laser weld joints. At each weld site where laser welding is performed, the laser beam is directed at the stacked panels and conveyed a short distance to produce the weld joint in one of a variety of configurations including, for example, a spot weld joint, a stitch weld joint, or a staple weld joint. The process of laser welding inner and outer door panels (as well as other vehicle part components such as those used to fabricate hoods, deck lids, load-bearing structural members, etc.) is typically an automated process that can be carried out quickly and efficiently.

Aluminum workpieces are an intriguing candidate for many automobile component parts and structures due to their high strength-to-weight ratio and their ability to improve the fuel economy of the vehicle. The use of laser welding to join together aluminum workpieces, however, can present challenges. Most notably, aluminum workpieces almost always include a protective coating that covers an underlying bulk aluminum substrate. This protective coating may be a refractory oxide coating that forms passively when fresh aluminum is exposed to atmospheric air or some other oxygen-containing medium. In other instances, the protective coating may be a metallic coating comprised of zinc or tin, or it may be a metal oxide conversion coating comprised of oxides of titanium, zirconium, chromium, or silicon, as disclosed in U.S. Patent Application No. US2014/0360986, the entire contents of which are incorporated herein by reference. The protective coating inhibits corrosion of the underlying aluminum substrate through any of a variety of mechanisms depending on the composition of the coating. But the presence of the protective anti-corrosion coating also makes it more challenging to autogenously fusion weld aluminum workpieces together by way of laser welding.

The protective anti-corrosion coating is believed to affect the laser welding process by contributing to the formation of weld defects in the final laser weld joint. When, for example, the protective anti-corrosion coating is a passive refractory oxide coating, the coating is difficult to break apart and disperse due to its high melting point and mechanical toughness. As a result, near-interface defects such as residual oxides, porosity, and micro-cracks are oftentimes found in the laser weld joint. As another example, if the protective anti-corrosion coating is zinc, the coating may readily vaporize to produce high-pressure zinc vapors (zinc has a boiling point of about 906° C.) at the faying interface(s) of the aluminum workpieces. These zinc vapors may, in turn, diffuse into and through the molten aluminum weld pool created by the laser beam and lead to entrained porosity in the final laser weld joint unless provisions are made to vent the zinc vapors away from the weld site, which may involve subjecting the workpiece stack-up to additional and inconvenient manufacturing steps prior to welding. The other materials mentioned above that may constitute the protective anti-corrosion coating can present similar issues that may ultimately affect and degrade the mechanical properties of the weld joint.

The unique challenges that underlie the use of laser welding to fusion join aluminum workpieces together have lead many manufactures to reject laser welding as a suitable metal joining process despite its potential to bestow a wide range of benefits. In lieu of laser welding, these manufacturers have turned to mechanical fasteners, such self piercing rivets or flow-drill screws, to join together two or more aluminum workpieces. Such mechanical fasteners, however, take much longer to put in place and have high consumable costs compared to laser weld joints. They also increase manufacturing complexity and add extra weight to the part being manufactured—weight that is avoided when joining is accomplished by way of autogenous fusion laser welds—that offsets some of the weight savings attained through the use of aluminum workpieces in the first place. A comprehensive laser welding strategy that can make aluminum laser welding a viable option in even the most demanding manufacturing settings would thus be a welcome addition to the art.

### SUMMARY OF THE DISCLOSURE

A method of laser spot welding a workpiece stack-up that includes overlapping aluminum workpieces is disclosed. The workpiece stack-up includes two or more aluminum workpieces, and at least one of those aluminum workpieces (and preferably all of the aluminum workpieces) includes a protective anti-corrosion coating. The term “aluminum workpiece” as used in the present disclosure refers broadly to a workpiece that includes a base aluminum substrate comprised of at least 85 wt % aluminum. The aluminum workpieces may thus include a base aluminum substrate comprised of elemental aluminum or any of a wide variety of aluminum alloys. Moreover, the protective anti-corrosion coating that covers at least one of the base aluminum substrates of the two or more aluminum workpieces is preferably the refractory oxide coating that passively forms when fresh aluminum is exposed to atmospheric air or some other source of oxygen. In alternative embodiments, however, the protective anti-corrosion coating may be a zinc coating, a tin coating, or a metal oxide conversion coating. The base aluminum substrate in any or all of the two or more aluminum workpieces may also be subjected to a variety of tempering procedures including annealing, strain hardening, and solution heat treating, if desired.

To begin, the laser spot welding method involves providing a workpiece stack-up that includes two or more overlapping aluminum workpieces (e.g, two or three overlapping aluminum workpieces). The aluminum workpieces are superimposed on each other such that a faying interface is established between the faying surfaces of each pair of adjacent overlapping aluminum workpieces. For example, in one embodiment, the workpiece stack-up includes first and second aluminum workpieces having first and second faying surfaces, respectively, that overlap and confront one another to establish a single faying interface. In another embodiment, the workpiece stack-up includes an additional third aluminum workpiece situated between the first and second aluminum workpieces. In this way, the first and second aluminum workpieces have first and second faying surfaces, respectively, that overlap and confront opposed faying surfaces of the third aluminum workpiece to establish two faying interfaces. When a third aluminum workpiece is present, the first and second aluminum workpieces may be separate and distinct parts or, alternatively, they may be different portions of the same part, such as when an edge of one part is folded back over on itself and hemmed over a free edge of another part.

After the workpiece stack-up is provided, a laser beam is directed at, and impinges, a top surface of the workpiece stack-up to create a molten aluminum weld pool that penetrates into the workpiece stack-up from the top surface towards the bottom surface. The power density of the laser beam is selected to carry out the laser welding method in keyhole welding mode at least part of the time. In keyhole welding mode, the power density of the laser beam is high enough to vaporize the aluminum workpieces and produce a keyhole directly underneath the laser beam within the molten aluminum weld pool. The keyhole provides a conduit for energy absorption deeper into workpiece stack-up which, in turn, facilitates deeper and narrower penetration of the molten aluminum weld pool. As such, the molten aluminum weld pool created during keyhole welding mode typically has a width at the top surface of the workpiece stack-up that is less than the penetration depth of the weld pool. The keyhole preferably penetrates the workpiece stack-up only partially during the disclosed laser spot welding method; that is, the keyhole extends into the workpiece stack-up from the top surface but does not extend all the way through the stack-up to the bottom surface.

The laser beam is advanced relative to the top surface of the workpiece stack-up along a spot weld travel pattern following creation of the molten aluminum weld pool and the partially-penetrating keyhole. Advancing the laser beam along the spot weld travel pattern translates the molten aluminum weld pool along a route that corresponds to the patterned movement of the laser beam relative to the top surface of the workpiece stack-up. Consequently, advancement of the laser beam along the spot weld travel pattern leaves behind a trail of molten aluminum workpiece material in the wake of the travel path of the laser beam and the corresponding route of the weld pool. This trail of molten aluminum workpiece material quickly cools and solidifies into resolidified composite aluminum workpiece material that is comprised of aluminum material from each aluminum workpiece penetrated by the molten aluminum weld pool. The collective resolidified composite aluminum workpiece material obtained from advancing the laser beam along the spot weld travel pattern provides a spot weld joint that autogenously fusion welds the aluminum workpieces together. Once the laser beam has completed its advancement along the spot weld travel pattern, the laser beam is removed from the top surface of the workpiece stack-up, typically by halting transmission of the laser beam.

The spot weld travel pattern traced by the laser beam includes one or more nonlinear inner weld paths enclosed by an outer peripheral weld path as projected onto a plane (the x-y plane) of the top surface of the workpiece stack-up. The one or more nonlinear inner weld paths may assume any of a variety of profiles relative to the top surface. For example, the one or more nonlinear inner weld paths may comprise a plurality of radially spaced and unconnected circular weld paths (such as a series of concentric circular weld paths). In this case, the laser beam jumps between and is advanced along multiple discrete circular inner weld paths in order to translate the molten aluminum weld pool and the associated keyhole along a corresponding series of circular routes during formation of the spot weld joint. As another example, the one or more nonlinear inner weld paths may comprise a spiral weld path that revolves around and expands radially outwardly from a fixed interior point. In this case, the laser beam is advanced along a radially-expanding revolution, either towards or away from the fixed interior point, to translate the molten aluminum weld pool and the associated keyhole along a corresponding spiral route during formation of the spot weld joint. The one or more nonlinear inner weld paths may, of course, assume a variety of other spatial profiles in addition to circles and spirals.

The outer peripheral weld path surrounds the one or more nonlinear inner weld paths and generally defines an outer boundary of the spot weld travel pattern. The outer peripheral weld path may be a circle, an ellipse, an epicycloid, an epitrochoid, or a hypocycloid, among other options, and it preferably has a diameter that ranges from 4 mm to 15 mm as measured between the two points on the outer peripheral weld path that are separated from each other by the greatest distance that intersects a midpoint of the outer peripheral weld path. While the outer peripheral weld path is preferably closed entirely, it does not necessarily have to be. For example, the outer peripheral weld path may include intermittent interruptions or may stop just short of full enclosure. Still further, the outer peripheral weld path may be interconnected with the one or more nonlinear inner weld paths or it may be a discrete weld path that is spaced-apart and distinct from the one or more nonlinear inner weld paths. A spiral inner weld path, for example, may seamlessly transition into the outer peripheral weld path, while, as another example, a plurality of radially spaced inner circular weld paths may be unconnected and thus distinct from the outer peripheral weld path, among other possibilities.

The one or more nonlinear inner weld paths and the outer peripheral weld path may be traced by the laser beam in any desired sequence. The one or more nonlinear inner weld paths may be traced first, followed by the outer peripheral weld path. Or, alternatively, the outer peripheral weld path may be traced first, followed by the one or more nonlinear inner weld paths. Additionally, the one or more nonlinear weld paths themselves may be traced by the laser beam in a variety of ways. For example, if the spot weld travel pattern includes a plurality of radially-spaced and unconnected circular inner weld paths surrounded by a circular outer peripheral weld path, the laser beam may start by tracing the innermost circular inner weld path (one of the nonlinear inner weld paths) and then continue tracing successively larger circular paths (the rest of the nonlinear inner weld paths) until it traces the outermost circular weld path (the outer peripheral weld path). Alternatively, the laser beam may proceed from the outermost circular path to the innermost circular path, or it may proceed by tracking the several discrete circular paths in some other sequence. Similarly, if the spot weld travel pattern includes a spiral inner weld path that connects with a circular outer peripheral weld path, the laser beam may start at the fixed interior point of the spiral inner weld path and revolve around and away from that point until it transitions into the circular outer peripheral weld path, or it may start with the circular outer peripheral weld path and revolve around and towards the fixed interior point of the spiral until it completes tracing the spiral inner weld path.

The depth of penetration of the partially-penetrating keyhole may be different along the one or more nonlinear inner weld paths and the surrounding outer peripheral weld path. In particular, when being conveyed along the one or more nonlinear inner weld paths, the keyhole (and thus the surrounding molten aluminum weld pool) penetrates deep enough into the workpiece stack-up towards the bottom surface to intersect each of the faying interfaces established within the stack-up between the top and bottom surfaces. This level of keyhole penetration produces resolidified composite aluminum workpiece material that extends across each of the faying interfaces to give the weld joint its capacity to fusion weld the overlapping aluminum workpieces together. As for the outer peripheral weld path, the keyhole may intersect each of the faying interfaces established within the stack-up between the top and bottom surfaces, but it does not necessarily have to. A shallower keyhole may be translated along the outer peripheral weld path, if desired, to create a smoother transition between the weld joint and the surrounding portion of the top surface of the workpiece stack-up outside of the weld joint. A smoother transition may help avoid the formation of stress points around the edge of the weld joint on the top surface of the stack-up.

Advancing the laser beam along the spot weld travel pattern is believed to provide the resulting weld joint with satisfactory strength. Specifically, without being bound by theory, it is believed that advancing the laser beam along the nonlinear inner weld path(s) and the outer peripheral weld path in a locally confined area promotes greater disturbance (e.g., fracture and break down, vaporization, or otherwise) of the protective anti-corrosion coating as compared to conventional laser welding practices. This, in turn, helps minimize the prevalence of entrained gas porosity and other weld defects within the weld joint that tend to detract from the strength, particularly the peel strength, of the weld joint. In addition to being advanced along the spot weld travel pattern, the strength of the weld joint may be enhanced in some instances in one of two ways: (1) advancing the laser beam first along the peripheral outer weld path and then in a direction from the outermost nonlinear inner weld path or weld path portion to the innermost nonlinear inner weld path or weld path portion when the inner weld paths are arranged to allow for such advancement of the laser beam (e.g., concentric circles or a spiral); or (2) remelting and resolidifying a peripheral portion of the weld joint with the laser beam after the laser beam is advanced along the spot weld travel pattern. Both of these practices can of course be implemented in combination with one another.

### BRIEF DESCRIPTION OF THE DRAWINGS

FIG. 1 is a perspective view of an embodiment of a remote laser welding apparatus for producing a spot weld joint within a workpiece stack-up that includes two or more overlapping aluminum workpieces;

FIG. 2 is a cross-sectional side view (taken along line 2-2) of the workpiece stack-up depicted in FIG. 1 along with a molten aluminum weld pool and a keyhole formed by a laser beam that is impinging a top surface of the workpiece stack-up;

FIG. 3 is a cross-sectional side view of the workpiece stack-up taken from the same perspective as shown in FIG. 2, although here the workpiece stack-up includes three aluminum workpieces that establish two faying interfaces, as opposed to two aluminum workpieces that establish a single faying interface as depicted in FIG. 2;

FIG. 4 depicts an embodiment of the spot weld travel pattern as projected onto the top surface of the workpiece stack-up that may be traced by a laser beam, and thus followed by a keyhole and surrounding molten aluminum weld pool, during formation of a spot weld joint between the two or more overlapping aluminum workpieces included in the workpiece stack-up;

FIGS. 4A through 4D depict a variety of exemplary spot weld travel patterns as projected onto the top surface the workpiece stack-up that are similar to the spot weld travel pattern shown in FIG. 4;

FIG. 5 depicts another embodiment of the spot weld travel pattern as projected onto the top surface of the workpiece stack-up that may be traced by a laser beam, and thus followed by a keyhole and surrounding molten aluminum weld pool, during formation of a spot weld joint between the two or more overlapping aluminum workpieces included in the workpiece stack-up;

FIGS. 5A through 5F depict a variety of exemplary spot weld travel patterns as projected onto the top surface the workpiece stack-up that are similar to the spot weld travel pattern shown in FIG. 5;

FIG. 6 depicts yet another embodiment of the spot weld travel pattern as projected onto the top surface of the workpiece stack-up that may be traced by a laser beam, and thus followed by a keyhole and surrounding molten aluminum weld pool, during formation of a spot weld joint between the two or more overlapping aluminum workpieces included in the workpiece stack-up;

FIG. 7 depicts still another embodiment of the spot weld travel pattern as projected onto the top surface of the workpiece stack-up that may be traced by a laser beam, and thus followed by a keyhole and surrounding molten aluminum weld pool, during formation of a spot weld joint between the two or more overlapping aluminum workpieces included in the workpiece stack-up

FIG. 8 is a plan view of a laser spot weld joint produced by advancing the laser beam along the spot weld travel pattern and further depicting a peripheral portion of the weld joint that may be remelted and resolidified according to an embodiment of the present disclosure.

### DETAILED DESCRIPTION

The disclosed method of laser welding a workpiece stack-up comprised of two or more overlapping aluminum workpieces calls for advancing a laser beam relative to a plane of a top surface of the workpiece stack-up along a spot weld travel pattern. The disclosed spot weld travel pattern includes one or more nonlinear inner weld paths surrounded by a peripheral outer weld path. Any type of laser welding apparatus, including remote and conventional laser welding apparatuses, may be employed to advance the laser beam relative to the top surface of the workpiece stack-up. The laser beam may be a solid-state laser beam or a gas laser beam depending on the characteristics of the aluminum workpieces being joined and the laser welding apparatus being used. Some notable solid-state lasers that may be used are a fiber laser, a disk laser, and a Nd:YAG laser, and a notable gas laser that may be used is a CO₂ laser, although other types of lasers may certainly be used so long as they are able to create the keyhole and surrounding molten aluminum weld pool. In a preferred implementation of the disclosed method, which is described below in more detail, a remote laser welding apparatus directs and advances a solid-state laser beam at and along the top surface of the workpiece stack-up.

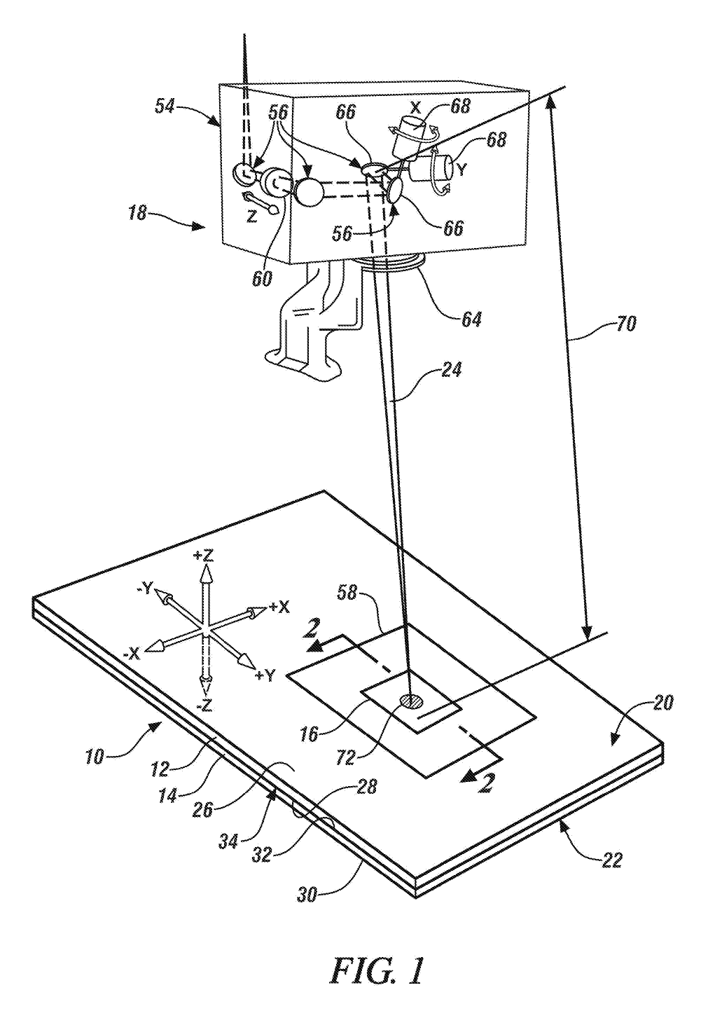

Referring now to FIGS. 1-3, a method of laser welding a workpiece stack-up 10 is illustrated in which the workpiece stack-up 10 includes at least a first aluminum workpiece 12 and a second aluminum workpiece 14 that overlap at a weld site 16 where laser welding is practiced using a remote laser welding apparatus 18. The first and second aluminum workpieces 12, 14 respectively provide a top surface 20 and a bottom surface 22 of the workpiece stack-up 10. The top surface 20 of the workpiece stack-up 10 is made available to the remote laser welding apparatus 18 and can be accessed by a laser beam 24 emanating from the remove laser welding apparatus 18. And since only single side access is needed to perform remote laser welding, there is no need for the bottom surface 22 of the workpiece stack-up 10 to be made available to the remote laser welding apparatus 18 in the same way as the top surface 20. Moreover, while only one weld site 16 is depicted in the Figures for the sake of simplicity, skilled artisans will appreciate that laser welding in accordance with the disclosed method can be practiced at multiple different weld sites spread throughout the same workpiece stack-up 10.

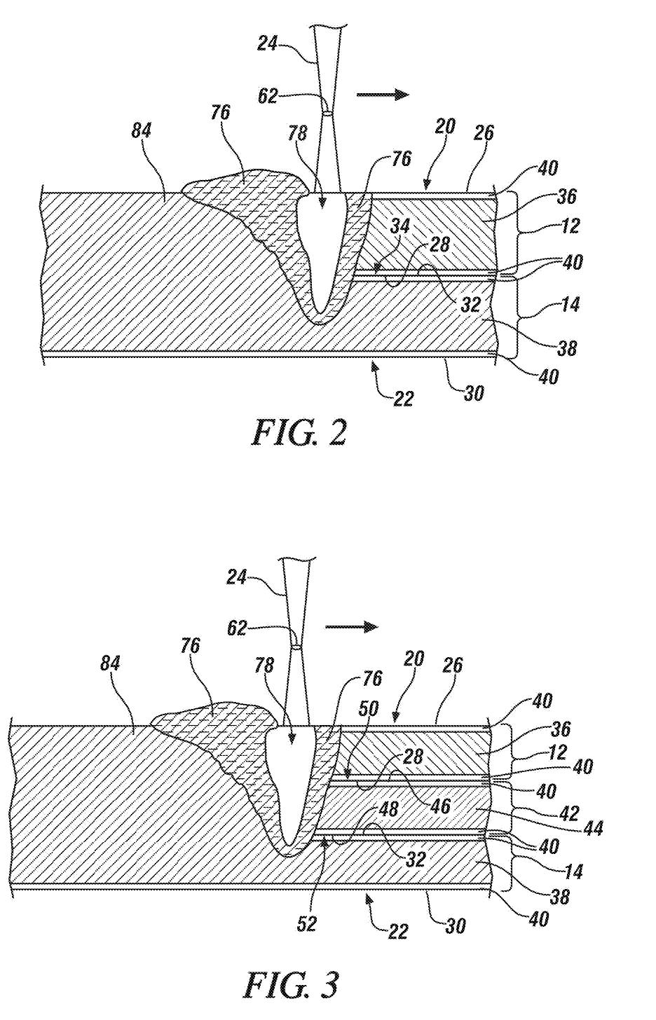

As far as the number of aluminum workpieces present, the workpiece stack-up 10 may, as shown in FIGS. 1-2, include only the first and second aluminum workpieces 12, 14. In this scenario, the first aluminum workpiece 12 includes an outer surface 26 and a first faying surface 28, and the second aluminum workpiece 14 includes an outer surface 30 and a second faying surface 32. The outer surface 26 of the first aluminum workpiece 12 provides the top surface 20 of the workpiece stack-up 10 and the outer surface 30 of the second aluminum workpiece 14 provides the oppositely-facing bottom surface 22 of workpiece stack-up 10. Conversely, since the two aluminum workpieces 12, 14 are the only two workpieces present in the workpiece stack-up 10, the first and second faying surfaces 28, 32 of the first and second aluminum workpieces 12, 14 overlap and confront one another to establish a faying interface 34 that extends through the weld site 16. In other embodiments, one of which is describe below in connection with FIG. 3, the workpiece stack-up 10 may include an additional aluminum workpiece such that the workpiece stack-up 10 includes three aluminum workpieces instead of only two as shown in FIGS. 1-2.

The term “faying interface” is used broadly in the present disclosure and is intended to encompass a wide range of overlapping relationships between the confronting first and second faying surfaces 28, 32 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer—and thus do not experience the type of extensive interfacial abutment that typifies direct contact—yet are in close enough proximity that laser welding can be practiced. As another example, the faying surfaces 28, 32 may establish the faying interface 34 by being separated by gaps that are purposefully imposed. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the faying surfaces 28, 32 spaced apart outside of and around the contact points by up to 1.0 mm and, preferably, between 0.2 mm and 0.8 mm.

As shown best in FIG. 2, the first aluminum workpiece 12 includes a first base aluminum substrate 36 and the second aluminum workpiece 14 includes a second base aluminum substrate 38. Each of the base aluminum substrates 36, 38 may be separately composed of elemental aluminum or an aluminum alloy that includes at least 85 wt % aluminum. Some notable aluminum alloys that may constitute the first and/or second base aluminum substrates 36, 38 are an aluminum-magnesium alloy, an aluminum-silicon alloy, an aluminum-magnesium-silicon alloy, or an aluminum-zinc alloy. Additionally, each of the base aluminum substrates 36, 38 may be separately provided in wrought or cast form. For example, each of the base aluminum substrates 36, 38 may be composed of a 4xxx, 5xxx, 6xxx, or 7xxx series wrought aluminum alloy sheet layer, extrusion, forging, or other worked article. Or, as another example, each of the base aluminum substrates 36, 38 may be composed a 4xx.x, 5xx.x, or 7xx.x series aluminum alloy casting. Some more specific kinds of aluminum alloys that can be used as the first and/or second base aluminum substrate 36, 38 include, but are not limited to, AA5754 aluminum-magnesium alloy, AA6022 aluminum-magnesium-silicon alloy, AA7003 aluminum-zinc alloy, and Al-10Si—Mg aluminum die casting alloy. The first and/or second base aluminum substrate 36, 38 may be employed in a variety of tempers including annealed (O), strain hardened (H), and solution heat treated (T) depending on the desired properties of the workpieces 12, 14.

At least one of the first or second aluminum workpieces 12, 14—and preferably both—includes a protective anti-corrosion coating 40 that overlies the base aluminum substrate 36, 38. Indeed, as shown in FIG. 2, each of the first and second base aluminum substrates 36, 38 is coated with a protective anti-corrosion coating 40 that, in turn, provides the workpieces 12, 14 with their respective outer surfaces 26, 30 and their respective faying surfaces 28, 32. The protective anti-corrosion coating 40 may be a refractory oxide coating that forms passively when fresh aluminum from the base aluminum substrate 36, 38 is exposed to atmospheric air or some other oxygen-containing medium. The protective anti-corrosion coating 40 may also be a metallic coating comprised of zinc or tin, or it may be a metal oxide conversion coating comprised of oxides of titanium, zirconium, chromium, or silicon. A typical thickness of the protective anti-corrosion coating 38, if present, lies anywhere from 1 nm to 10 μm depending on its composition. Taking into account the thickness of the base aluminum substrates 36, 38 and the protective anti-corrosion coatings 40, the first and second aluminum workpieces 12, 14 may have thicknesses in the range of 0.3 mm to 6.0 mm, and more specifically in the range of 0.5 mm to 3.0 mm, at least at the weld site 16. The thicknesses of the first and second aluminum workpieces 12, 14 may be the same as or different from each other.

FIGS. 1-2 illustrate an embodiment of the remote laser welding method in which the workpiece stack-up 10 includes two overlapping aluminum workpieces 12, 14 that have the single faying interface 34. Of course, as shown in FIG. 3, the workpiece stack-up 10 may include an additional third aluminum workpiece 42 situated between the first and second aluminum workpieces 12, 14. The third aluminum workpiece 42, if present, includes a third base aluminum substrate 44 that may be bare or coated with the same protective anti-corrosion coating 40 (as shown) described above. Indeed, when the workpiece stack-up 10 includes the first, second, and third overlapping aluminum workpieces 12, 14, 42, the base aluminum substrate 36, 38, 44 of at least one of the workpieces 12, 14, 42, and preferably all of them, includes the protective anti-corrosion coating 40. As for the characteristics of the third base aluminum substrate 44, the descriptions above regarding the first and second base aluminum substrates 36, 38 are equally applicable to that substrate 44 as well.

As a result of stacking the first, second, and third aluminum workpieces 12, 14, 42 in overlapping fashion to provide the workpiece stack-up 10, the third aluminum workpiece 42 has two faying surfaces 46, 48. One of the faying surfaces 46 overlaps and confronts the faying surface 28 of the first aluminum workpiece 12 and the other faying surface 48 overlaps and confronts the faying surface 32 of the second aluminum workpiece 14, thus establishing two faying interfaces 50, 52 within the workpiece stack-up 10 that extend through the weld site 16. These faying interfaces 50, 52 are the same type and encompass the same attributes as the faying interface 34 already described with respect to FIGS. 1-2. Consequently, in this embodiment as described herein, the outer surfaces 26, 30 of the flanking first and second aluminum workpieces 12, 14 still generally face away from each other in opposite directions and constitute the top and bottom surfaces 20, 22 of the workpiece stack-up 10. Skilled artisans will know and appreciate that the remote laser welding method, including the following disclosure directed to a workpiece stack-up that includes two aluminum workpieces, can be readily adapted and applied to a workpiece stack-up that includes three overlapping aluminum workpieces without undue difficulty.

Referring back to FIGS. 1-3, the remote laser welding apparatus 18 includes a scanning optic laser head 54. The scanning optic laser head 54 focuses and directs the laser beam 24 at the top surface 20 of the workpiece stack-up 10 which, here, is provided by the outer surface 26 of the first aluminum workpiece 12. The scanning optic laser head 54 is preferably mounted to a robotic arm (not shown) that can quickly and accurately carry the laser head 54 to many different preselected weld sites on the workpiece stack-up 10 in rapid programmed succession. The laser beam 24 used in conjunction with the scanning optic laser head 54 is preferably a solid-state laser beam and, in particular, a fiber laser beam or a disk laser beam operating with a wavelength in the near-infrared range (commonly considered to be 700 nm to 1400 nm) of the electromagnetic spectrum. A preferred fiber laser beam is any laser beam in which the laser gain medium is either an optical fiber doped with rare-earth elements (e.g., erbium, ytterbium, neodymium, dysprosium, praseodymium, thulium, etc.) or a semiconductor associated with a fiber resonator. A preferred disk laser beam is any laser beam in which the gain medium is a thin disk of ytterbium-doped yttrium-aluminum Garnet crystal coated with a reflective surface and mounted to a heat sink.

The scanning optic laser head 54 includes an arrangement of mirrors 56 that can maneuver the laser beam 24 relative to a plane oriented along a the top surface 20 of the workpiece stack-up 10 within an operating envelope 58 that encompasses the weld site 16. Here, as illustrated in FIG. 1, the plane of the top surface 20 spanned by the operating envelope 58 is labeled the x-y plane since the position of the laser beam 24 within the plane is identified by the “x” and “y” coordinates of a three-dimensional coordinate system. In addition to the arrangement of mirrors 56, the laser head 54 also includes a z-axis focal lens 60, which can move a focal point 62 (FIGS. 2-3) of the laser beam 24 in a z-direction that is oriented perpendicular to the x-y plane in the three-dimensional coordinate system established in FIG. 1. Furthermore, to keep dirt and debris from adversely affecting the optical system and the integrity of the laser beam 24, a cover slide 64 may be situated below the scanning optic laser head 54. The cover slide 64 protects the arrangement of mirrors 56 and the z-axis focal lens 60 from the surrounding environment yet allows the laser beam 24 to pass out of the laser head 54 without substantial disruption.

The arrangement of mirrors 56 and the z-axis focal lens 60 cooperate during remote laser welding to dictate the desired movement of the laser beam 24 within the operating envelope 58 at the weld site 16 as well as the position of the focal point 62 along the z-axis. The arrangement of mirrors 58, more specifically, includes a pair of tiltable scanning mirrors 66. Each of the tiltable scanning mirrors 66 is mounted on a galvanometer 68. The two tiltable scanning mirrors 66 can move the location at which the laser beam 24 impinges the top surface 20 of the workpiece stack-up 10 anywhere in the x-y plane of the operating envelope 58 through precise coordinated tilting movements executed by the galvanometers 68. At the same time, the z-axis focal lens 60 controls the location of the focal point 62 of the laser beam 24 in order to help administer the laser beam 24 at the correct power density. All of these optical components 60, 66 can be rapidly indexed in a matter of milliseconds or less to advance the laser beam 24 relative to the top surface 20 of the workpiece stack-up 10 along a spot weld travel pattern that includes one or more nonlinear inner weld paths and a surrounding peripheral outer weld path. Examples of such spot weld travel patterns are described in greater detail below.

A characteristic that differentiates remote laser welding (also sometimes referred to as “welding on the fly”) from other conventional forms of laser welding is the focal length of the laser beam 24. Here, as shown in best in FIG. 1, the laser beam 24 has a focal length 70, which is measured as the distance between the focal point 62 and the last tiltable scanning mirror 66 that intercepts and reflects the laser beam 24 prior to the laser beam 24 impinging the top surface 20 of the workpiece stack-up 10 (also the outer surface 26 of the first aluminum workpiece 12). The focal length 70 of the laser beam 24 is preferably in the range of 0.4 meters to 1.5 meters with a diameter of the focal point 62 typically ranging anywhere from 350 μm to 700 μm. The scanning optic laser head 54 shown generally in FIG. 1 and described above, as well as others that may be constructed somewhat differently, are commercially available from a variety of sources. Some notable suppliers of scanning optic laser heads and lasers for use with the remote laser welding apparatus 18 include HIGHYAG (Kleinmachnow, Germany) and TRUMPF Inc. (Farmington, Conn., USA).

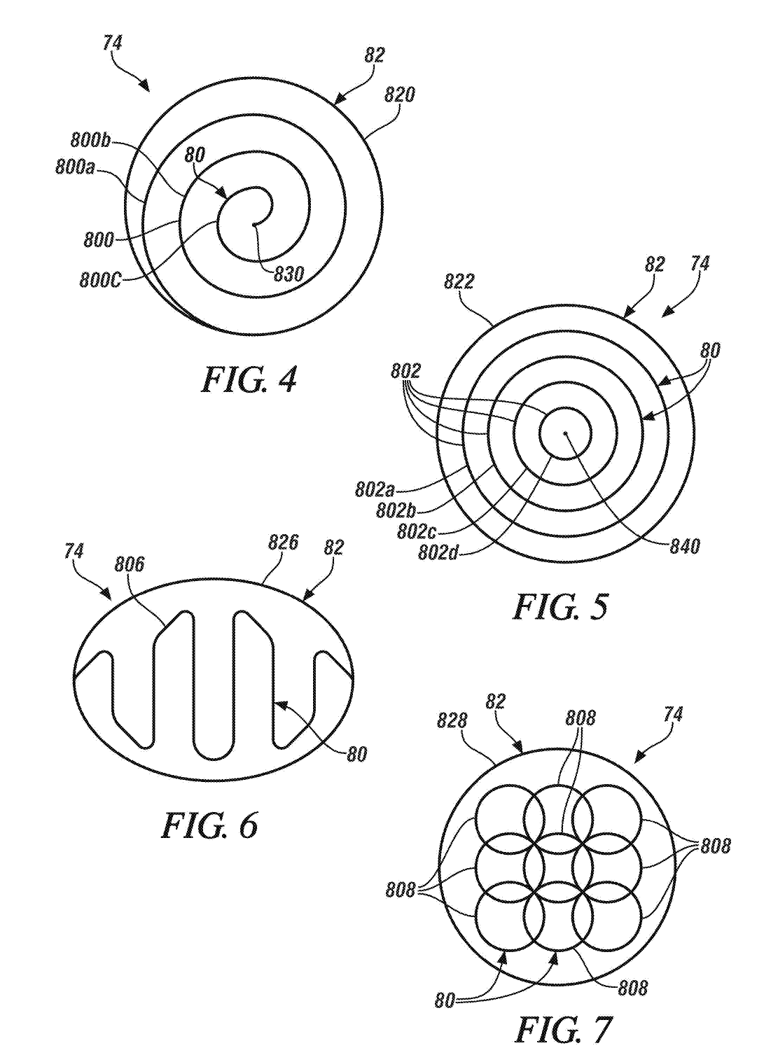

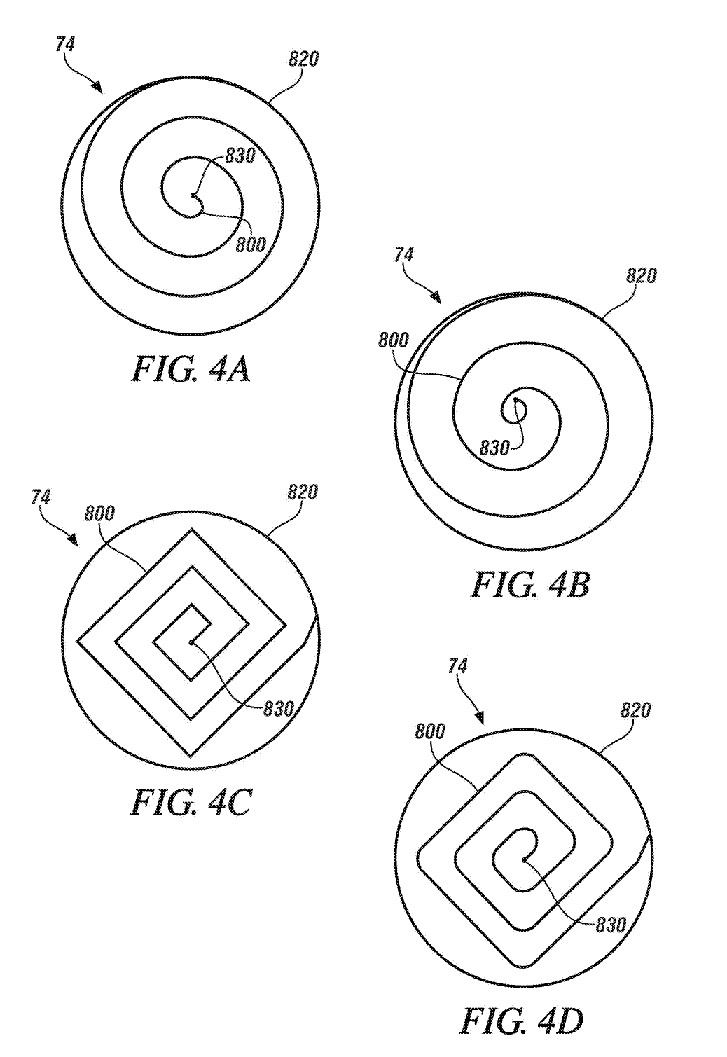

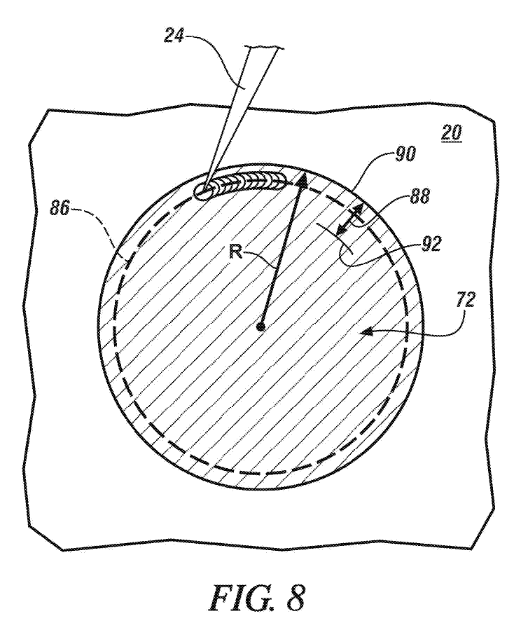

In the presently disclosed method, as illustrated generally in the Figures, a laser spot weld joint 72 (FIGS. 1 and 8) is formed between the first and second aluminum workpieces 12, 14 (or between the first, second, and third aluminum workpieces 12, 14, 42 as shown in FIG. 3) by advancing the laser beam 24 along a particular spot weld travel pattern 74 (FIGS. 4-7) relative to the top surface 20 of the workpiece stack-up 10. As shown best in FIGS. 2-3, the laser beam 24 is initially directed at, and impinges, the top surface 20 of the workpiece stack-up 10 within the weld site 16. The heat generated from absorption of the focused energy of the laser beam 24 initiates melting of the first and second aluminum workpieces 12, 14 (and the third aluminum workpiece 42 if present) to create a molten aluminum weld pool 76 that penetrates into the workpiece stack-up 10 from the top surface 20 towards the bottom surface 22. The laser beam 24 also has a power density sufficient to vaporize the workpiece stack-up 10 directly beneath where it impinges the top surface 20 of the stack-up 10. This vaporizing action produces a keyhole 78, which is a column of vaporized aluminum that usually contains plasma. The keyhole 78 is formed within the molten aluminum weld pool 76 and exerts an outwardly-directed vapor pressure sufficient to prevent the surrounding molten aluminum weld pool 76 from collapsing inward.

Like the molten aluminum weld pool 76, the keyhole 78 also penetrates into the workpiece stack-up 10 from the top surface 20 towards the bottom surface 22. The keyhole 78 provides a conduit for the laser beam 24 to deliver energy down into the workpiece stack-up 10, thus facilitating relatively deep and narrow penetration of the molten aluminum weld pool 76 into the workpiece stack-up 10 and a relatively small surrounding heat-affected zone. In a preferred embodiment, the keyhole 78 and the surrounding molten aluminum weld pool 76 partially penetrate the workpiece stack-up 10. In other words, the keyhole 78 and the molten aluminum weld pool extend into the stack-up 10 from the top surface 20, but do not extend all the way to and breach through the bottom surface 22 of the workpiece stack-up 10. The power level, travel velocity, and/or focal point position of the laser beam 24 may be controlled during the laser welding process so that the keyhole 78 and the molten aluminum weld pool 76 penetrate the workpiece stack-up 10 to the appropriate partially-penetrating depth, which may be varied as the laser beam 24 is advanced along certain portions of the spot weld travel pattern 74, as will be further explained below.

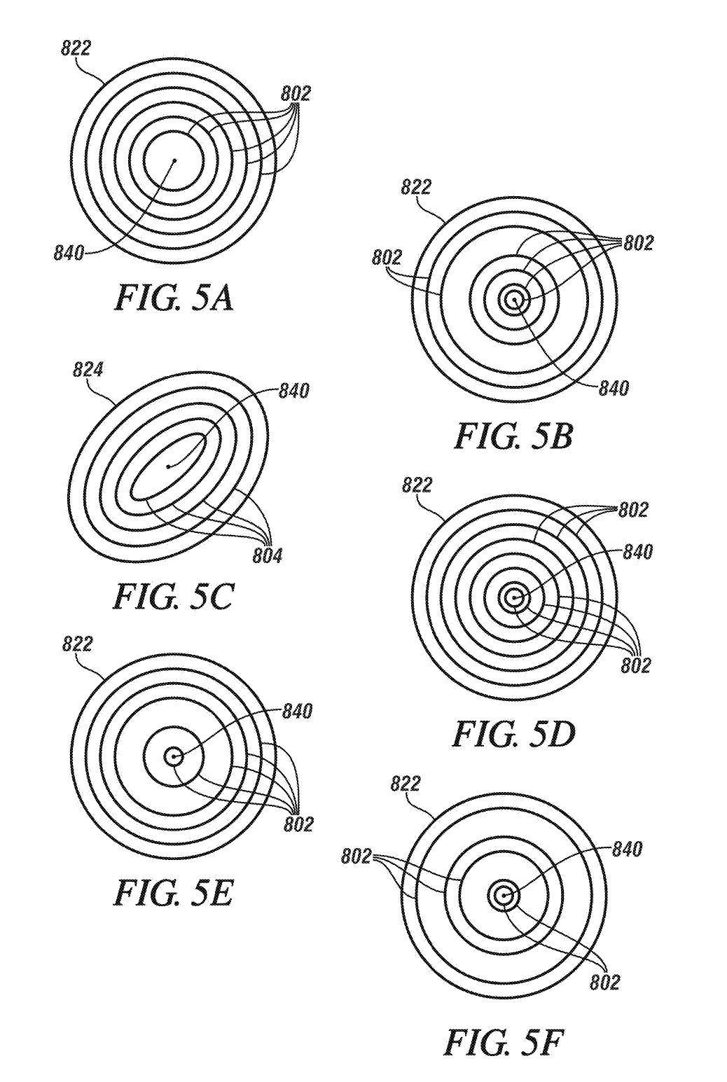

After the molten aluminum weld pool 76 and the keyhole 78 are created and stable, the laser beam 24 is advanced relative to the top surface 20 of the workpiece stack-up along the spot weld travel pattern 74. The geometric configuration of the spot weld travel pattern 74 tracked by the laser beam 24 enables the weld joint 72 to successfully fuse the first and second aluminum workpieces 12, 14 (and the additional intervening aluminum workpiece 42 if present) together at the weld site 16 despite the fact that at least one of the workpieces 12, 14 (and optionally 42) includes a protective anti-corrosion coating 40 that tends to be a source of weld defects. The spot weld travel pattern 74 may take on a variety of different configurations. In general, however, using FIGS. 4 and 5 as representative examples, the spot weld travel pattern 74 includes one or more nonlinear inner weld paths 80 and an outer peripheral weld path 82 that surrounds the one or more nonlinear inner weld paths 80. As noted above, the spot weld travel pattern 74 is traced by the laser beam 24 with respect to a plane oriented along the top surface 20 of the workpiece stack-up 10 at the weld site 16. As such, the illustrations presented in FIGS. 4, 4A-4D, 5, 5A-5F, and 6-7 are plan views, from above, of various exemplary spot weld travel patterns projected onto the top surface 20 of the workpiece stack-up 10. These views provide a visual understanding of how the laser beam 24 is advanced relative to the top surface 20 of the workpiece stack-up 10 during formation of the weld joint 72.

The one or more nonlinear inner weld paths 80 include a single weld path or a plurality of weld paths that include some curvature or deviation from linearity. Such weld paths may be continuously curved or they may be comprised of multiple straight line segments that are connected end-to-end at an angle to one another (i.e., the angle between the connected line segments ≠180°). The outer peripheral weld path 82 generally defines an outer periphery of the spot weld travel pattern 74 and preferably has a diameter that ranges from 4 mm to 15 mm as measured between the two points on the outer peripheral weld path 82 that are separated from each other by the greatest distance that intersects a midpoint of the outer peripheral weld path 82. While the outer peripheral weld path 82 is preferably a closed circle or a closed ellipse, it does not necessarily have to be either one of those geometric shapes, nor does it have to be closed in every instance. Moreover, the outer peripheral weld path 82 may be interconnected with the one or more nonlinear inner weld paths 80 (FIGS. 4, 4A-4D, and 6) or it may be spaced apart and distinct from the one or more nonlinear inner weld paths 80 (FIGS. 5, 5A-5F, and 7).

Referring now generally to FIGS. 4-7, which are plan views of several examples of the spot weld travel pattern 74 as projected onto the top surface 20 of the workpiece stack-up 10, the spot weld travel pattern 74 may comprise a closed-curve pattern, a spiral pattern, or some other pattern. A closed-curve pattern may be any pattern that includes a plurality of radially spaced and unconnected circular weld paths, elliptical weld paths, or weld paths having like closed curves, with a preferred number of such closed curves ranging from two to ten. A spiral pattern may be any pattern having a single weld path that emanates from a fixed interior point and expands radially outwardly from the fixed interior point as the weld path revolves around that point, with a preferred number of spiral turnings ranging from two to ten. The fixed interior point can be located at or near the center of the spot weld travel pattern 74, or may be offset from the center of the weld pattern 74. FIGS. 4-7 illustrate various examples of these types of weld patterns including their identified nonlinear inner weld path(s) 80 and outer peripheral weld path 82. Variations of these specifically illustrated spot weld travel patterns may be employed as well in the disclosed laser welding method.

FIGS. 4-4D illustrate several embodiments of the spot weld travel pattern 74 that comprise a single nonlinear inner weld path 80 surrounded by, and interconnected with, the outer peripheral weld path 82. Specifically, each of the weld pattern embodiments includes a spiral inner weld path 800 and a circular outer peripheral weld path 820. The spiral inner weld path 800 revolves around and expands radially outwardly from a fixed interior point 830 of the spot weld travel pattern 74 until it transitions into the circular outer peripheral weld path 820. The spiral inner weld path 800 may be continuously curved, as shown in FIGS. 4 and 4A-4B, and may further be an Archimedean spiral in which the turnings of the spiral inner weld path 800 are spaced equidistantly from each other as shown as shown in FIGS. 4 and 4A. The general equation of an Archimedean spiral in polar coordinates is r(θ)=a+b(θ), with “a” and “b” being real numbers and “b” determining the spacing between the turnings. The spiral inner weld path 800 may also constitute other types of spirals including, for example, an equiangular spiral in which the turnings of the spiral inner weld path get progressively farther apart. The general equation of an equiangular spiral in polar coordinates is r(θ)=ae^{b(θ)}, with “a” and “b” being real numbers and “b” determining how tightly the spiral inner weld path 800 is wrapped about the fixed interior point 830. Additionally, in other embodiments, the spiral inner weld path 800 may be comprised of straight line segments that together constitute a spiral, as shown in FIGS. 4C-4D, with the turnings being spaced equidistantly or not.

FIGS. 5-5F illustrate several embodiments of the spot weld travel pattern 74 that comprises a plurality of nonlinear inner weld paths 80 that are distinct from the outer peripheral weld path 82. Each of the weld patterns shown in FIGS. 5-5B and 5D-5F, for example, comprises a plurality of radially-spaced and unconnected circular inner weld paths 802 as well as a circular outer peripheral weld path 822. The circular inner weld paths 802 are concentrically arranged about a central point 840. These discrete circular weld paths 802 may be radially spaced evenly apart (FIGS. 5-5A) or they may be spaced apart at varying distances (FIGS. 5B and 5D-5F). Additionally, as shown, the circular outer peripheral weld path 822 may be concentrically arranged around the central point 840 along with the circular inner weld paths 802, although such a relationship between the circular inner weld paths 802 and the circular outer peripheral weld path 822 is not mandatory. Of course, several variations of the embodiments shown in FIGS. 5-5B and 5D-5F are possible. For instance, as shown in FIG. 5C, the spot weld travel pattern 74 may comprise a plurality of radially spaced and unconnected elliptical inner weld paths 804, instead of the plurality of circular inner weld paths 802, and may further be surrounded by an elliptical outer peripheral weld path 824. The embodiments of the spot weld travel pattern 74 illustrated in FIGS. 5-5F preferably include anywhere from two to ten inner weld paths 802, 804, or more narrowly anywhere from three to eight inner weld paths 802, 804.

Many other embodiments of the spot weld travel pattern 74 are indeed contemplated in addition to those shown in FIGS. 4-4D and 5-5F. In one such embodiment, the spot weld travel pattern 74 illustrated in FIG. 6 is similar to the spot weld travel patterns 74 illustrated in FIGS. 4-4D in that it comprises a single nonlinear inner weld path 80 surrounded by, and interconnected with, an outer peripheral weld path 82. Here, however, in FIG. 6, the weld pattern embodiment includes a serpentine inner weld path 806 and an elliptical outer peripheral weld path 826. The serpentine inner weld path 806 extends from one side of the elliptical outer peripheral weld path 826 to the other and is comprised of both curved and straight line segments. As another alternative, the spot weld travel pattern 74 illustrated in FIG. 7 is similar to the weld patterns illustrated in FIGS. 5-5F in that it comprises one or more nonlinear inner weld paths 80 that are distinct from the surrounding outer peripheral weld path 82. This embodiment of the spot weld travel pattern 74, however, comprises a plurality of circular inner weld paths 806 in which each of the circular inner weld paths 808 intersects at least one, and preferably at least two, of the other circular inner weld paths 808. In this particular instance, the plurality of circular inner weld paths 808 is surrounded by a circular outer peripheral weld path 828.

The laser beam 24 may be advanced along the nonlinear inner weld path(s) 80 and the outer peripheral weld path 82 of the spot weld travel pattern 74 in any sequence. The laser beam 24 may, for example, be conveyed first along the one or more nonlinear inner weld paths 80 and then along the outer peripheral weld path 82. In another example, the laser beam 24 may be conveyed first along the outer peripheral weld path 82 and then along the one or more nonlinear inner weld paths 80. Additionally, in embodiments where the spot weld travel pattern 74 includes a plurality of nonlinear inner weld paths 80, the laser beam 24 may be conveyed along the inner weld paths 80 in any order including from an innermost of the inner weld paths 80 to an outermost of the inner weld paths 80, from an outermost of the inner weld paths 80 to an innermost of the inner weld paths 80, or in some other order. Still further, in other embodiments, the laser beam 24 may be conveyed along some of the one or more nonlinear inner weld paths 80, then may be conveyed along the outer peripheral weld path 82, and finally may be conveyed along the rest of the one or more nonlinear inner weld paths 80 to complete the spot weld travel pattern 74. When the one or more nonlinear inner weld paths 80 are comprised of a spiral or concentric circles/ellipses, it may be preferably to advance the laser beam 24 in a radially inward direction from the outermost of the inner weld paths 80 to the innermost of the inner weld paths 80, as will be explained in greater detail below.

As the laser beam 24 is being advanced relative to the top surface 20 of the workpiece stack-up 10 along the spot weld travel pattern 74, the keyhole 78 and the molten aluminum weld pool 76 are consequently translated along a corresponding route relative to the top surface 20 since they track the movement of the laser beam 24. In this way, the molten aluminum weld pool 76 momentarily leaves behind a trail of molten aluminum workpiece material in the wake of the travel path of the laser beam 24 and the corresponding route of the weld pool 76. The molten aluminum workpiece material eventually cools and solidifies into resolidified composite aluminum workpiece material 84 (FIGS. 2-3) that is comprised of aluminum material from each of the aluminum workpieces 12, 14 (and 42 if present) penetrated by the molten aluminum weld pool 76. The collective resolidified composite aluminum workpiece material 84 obtained from advancing the laser beam 24 along the spot weld travel pattern 74 constitutes the weld joint 72 and autogenously fusion welds the aluminum workpieces 12, 14 (and 42 if present) together. Once the laser beam 24 is finished tracing the spot weld travel path 74, the transmission of the laser beam 24 is ceased so that the laser beam 24 no longer impinges the top surface 20 of the workpiece stack-up 10. At this time, the keyhole 78 collapses and the molten aluminum weld pool 76 solidifies.

The depth of penetration of the partially-penetrating keyhole 78 and the surrounding molten aluminum weld pool 76 during advancement of the laser beam 24 along the spot weld travel pattern 74 is controlled to ensure the aluminum workpieces 12, 14 (and optionally 42) are fusion welded together by the weld joint 72. In particular, as shown best in FIGS. 2-3, the keyhole 78 and the molten aluminum weld pool 76 intersect each faying interface 34 (or 50, 52) present within the workpiece stack-up 10 between the top and bottom surfaces 20, 22 of the stack-up 10 during advancement of the laser beam 24 along the one or more nonlinear inner weld paths 82. This means that the keyhole 78 and the molten aluminum weld pool 76 entirely traverse the thickness of the first aluminum workpiece 12 (and the thickness of the third aluminum workpiece 42 if present) yet only partially traverse the thickness of the second aluminum workpiece 14. By causing the keyhole 78 and the molten aluminum weld pool 76 to penetrate far enough into the workpiece stack-up 10 that they intersect each faying interface 34 (50, 52), but not quite all the way to the bottom surface 22, the resolidified composite aluminum workpiece material 84 derived along the nonlinear inner weld paths 80 serves to autogenously fusion weld the aluminum workpieces 12, 14 (and optionally 42) together within the weld joint 72.

When the laser beam 24 is being advanced along the outer peripheral weld path 82 of the spot weld travel pattern 74, the depth of penetration of the of the partially-penetrating keyhole 78 and the surrounding molten aluminum weld pool 76 can be the same as that employed for the one or more nonlinear inner weld paths 80, but they do not necessarily have to be. To be sure, the keyhole 78 and the surrounding molten aluminum weld pool 76 may intersect each faying interface 34 (50, 52) in much the same way as the nonlinear inner weld path(s) 80, and thus contribute to the fusion welding of the aluminum workpieces 12, 14 (and possibly 42) within the weld joint 72. In an alternative embodiment, however, the partially-penetrating keyhole 78 and the surrounding molten aluminum weld pool 76 may penetrate to a lesser extent into the workpiece stack-up 10 and intersect less than all of the faying interfaces 34 (50, 52), including none at all. A shallower penetration depth may be implemented when the laser beam 24 is being advanced along the outer peripheral weld path 82 to try and produce resolidified composite aluminum workpiece material 84 that provides for a smoother transition between the weld joint 72 and the surrounding area of the workpiece stack-up 10. The creation of a smoother transition helps avoid the formation of a sharp crest that can be easily stressed, helps prevent burn-through, and improves the visible appearance of the weld joint 72.

The depth of penetration of the keyhole 78 and the surrounding molten aluminum weld pool 76 can be controlled by various laser welding process parameters including the power level of the laser beam 24, the position of the focal point 62 of the laser beam 24 relative to the workpiece stack-up 10 (i.e., focal position) along the z-axis, and the travel velocity of the laser beam 24 relative to the workpiece stack-up 10. In general, the penetration of the keyhole 78 and the molten aluminum weld pool 76 can be increased by increasing the power level of the laser beam 24, focusing the laser beam 24 by moving the focal point 62 towards the bottom surface 22 of the workpiece stack-up 10 (i.e., in the −Z direction denoted FIG. 1), decreasing the travel velocity of the laser beam 24, or a combination thereof Conversely, the penetration depth of the keyhole 78 and the molten aluminum weld pool 76 can be decreased by decreasing the power level of the laser beam 24, defocusing the laser beam 24 by moving the focal point 62 away from the bottom surface 22 of the workpiece stack-up 10 (i.e., in the +Z direction denoted FIG. 1), increasing the travel velocity of the laser beam 24, or a combination thereof. Through these process parameters and the many ways they can be adjusted, the depth of the keyhole 78 and the molten aluminum weld pool 76 can be readily controlled to the extent desired as the laser beam 24 is advanced along the spot weld travel pattern 74.

The various process parameters that are used to dictate the penetration depth of the keyhole 78 and the surrounding molten aluminum weld pool 76 can be programmed into a weld controller capable of executing the instructions with precision as the laser beam 24 is being advanced along the spot weld travel pattern 74. The same weld controller or a different controller may synchronously control the galvanometers 68 in order to advance the laser beam 24 relative to the top surface 20 of the workpiece stack-up 10 along the weld paths 80, 82 of the spot weld travel pattern 74 in the desired sequence. While the various process parameters of the laser beam 24 can be instantaneously varied in conjunction with one another to attain the penetration depth of the keyhole 78 and the molten aluminum weld pool 76 at any particular portion of the spot weld travel pattern 74, in many instances, regardless of the profile of the spot weld travel pattern 72, the power level of the laser beam 24 may be set to between 0.2 kW and 50.0 kW, or more narrowly between 1.0 kW and 10 kW, the travel velocity of the laser beam 24 may be set to between 1.0 meters per minute and 50.0 meters per minute, or more narrowly between 2.0 meters per minute and 15.0 meters per minute, and the focal point 62 of the laser beam 24 is preferably set at the bottom surface 22 of the workpiece stack-up 10 (also the outer surface 30 of the second aluminum workpiece 14).

The advancement of the laser beam 24 along the spot weld travel pattern 74 is believed to impart good and repeatable strength, in particular peel strength, to the weld joint 72 by minimizing the prevalence of weld defects derivable from the protective anti-corrosion coating 40 present on one or more of the aluminum workpieces 12, 14 (and optionally 42). Without being bound by theory, it is believed that advancing the laser beam 24 along the one or more nonlinear inner weld paths 80 induces constant changes in the molten metal fluid velocity field which, in turn, causes more disturbance (e.g., fracture and break down of a refractory oxide coating, or boiling and zinc oxide formation of a zinc coating, etc.) of the protective anti-corrosion coating(s) 40 within the weld site 16 as compared to more conventional laser welding techniques. By forcing greater disturbance of the protective anti-corrosion coating(s) 40, gas porosity and other common weld joint discrepancies are less likely to weaken the weld joint 72.

The strength of the weld joint 72 may be further enhanced in some circumstances by taking one or both of the following actions during the laser welding method in addition to advancing the laser beam 24 along the spot weld travel pattern 74. First, if the one or more nonlinear inner weld paths 80 of the spot weld travel pattern 74 include weld paths or weld path portions that are radially spaced apart, such as the spirals in FIGS. 4-4D or the concentric circles/ellipses in FIGS. 5-5F, then the laser beam 24 may be advanced first along the outer peripheral weld path 82 and then along the one or more nonlinear inner weld paths 80 in a radially inward direction. For instance, referring now to FIGS. 4 and 5, advancing the laser beam 24 in a radially inward direction along the nonlinear inner weld path(s) 80 involves first tracing the outermost inner weld path 802a (FIG. 5) or the outermost inner weld path portion or turning 800a (FIG. 4). The laser beam 24 then continues moving radially inwardly to consecutively trace the inner weld paths 802b, 802c or weld path portions or turnings 800b until it finally traces the innermost inner weld path 802d or the innermost weld path portion or turning 800c. Advancing the laser beam 24 along the spot weld travel pattern 74 in a radially inward fashion can help enhance the strength of the weld joint 72 by driving or sweeping any weld defects that might develop towards the middle of the weld joint 72 where they are less prone to adversely affect joint strength.

Second, a peripheral portion 86 of the weld joint 72 may be remelted with the laser beam 24, and then allowed to resolidify, after the laser beam 24 has finished tracing the spot weld travel pattern 74, as illustrated in FIG. 8. The laser beam 24 may be conveyed around the weld joint 72 within an annular edge region 88 to remelt resolidified composite aluminum workpiece material 84 of the weld joint 72 in that region 88. The annular edge region 88 extends from a circumferential edge 90 of the weld joint 72 radially inward to an inner circumferential boundary 92 having a radius of seventy percent of a radius R of the weld joint 72 or 0.7 R. When the laser beam 24 is conveyed around the weld joint 72 within the annular edge region 88 to remelt the designated peripheral portion 86 of the joint 72, the laser beam 24 preferably produces a keyhole (not shown here) that penetrates into but not through the resolidified composite aluminum workpiece material 84 it encounters. The peripheral portion 86 may be disposed around at least 60% of the circumference of the weld joint 72 and, preferably, somewhere between 90% and 100% of the circumference of the weld joint 72. Remelting and resolidifying the peripheral portion 86 of the weld joint 72 can help enhance the strength of the joint 72 by removing or at least refining any weld defects that may have developed near the circumferential edge 90 of the weld joint 72. Such an outcome can positively affect the strength of the weld joint 72 since weld defects located near the circumferential edge 90 of the weld joint 72 are more detrimental to the strength and integrity of the joint 72 than weld defects located in the middle of the weld joint 72.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of remote laser welding a workpiece stack-up that includes at least two overlapping aluminum workpieces, the method comprising:
providing a workpiece stack-up that includes overlapping aluminum workpieces, the workpiece stack-up comprising at least a first aluminum workpiece and a second aluminum workpiece, the first aluminum workpiece providing a top surface of the workpiece stack-up and the second aluminum workpiece providing a bottom surface of the workpiece stack-up, wherein a faying interface is established between each pair of adjacent overlapping aluminum workpieces within the workpiece stack-up, and wherein at least one of the aluminum workpieces in the workpiece stack-up includes a protective anti-corrosion coating;
directing a laser beam at the top surface of the workpiece stack-up to produce a keyhole and a molten aluminum weld pool that surrounds the keyhole, each of the keyhole and the molten aluminum weld pool penetrating into the workpiece stack-up from the top surface of the stack-up towards the bottom surface of the stack-up; and
forming a weld joint by advancing the laser beam relative to a plane of the top surface of the workpiece stack-up and along a spot weld travel pattern so as to translate the keyhole and the surrounding molten aluminum weld pool along a corresponding route relative to the top surface of the workpiece stack-up, the spot weld travel pattern including one or more nonlinear inner weld paths and an outer peripheral weld path that surrounds the one or more nonlinear inner weld paths, and wherein the keyhole and the surrounding molten aluminum weld pool penetrate into the workpiece stack-up far enough that they intersect each faying interface within the stack-up, but do not reach the bottom surface, during advancement of the laser beam along the one or more nonlinear inner weld paths of spot weld travel pattern in order to provide the weld joint with resolidified composite aluminum workpiece material that fusion welds the overlapping aluminum workpieces in the workpiece stack-up together.

2. The method set forth in claim 1, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the first and second faying surfaces of the first and second aluminum workpieces overlap and confront to establish a faying interface.

3. The method set forth in claim 1, wherein the first aluminum workpiece has an outer surface and a first faying surface, and the second aluminum workpiece has an outer surface and a second faying surface, the outer surface of the first aluminum workpiece providing the top surface of the workpiece stack-up and the outer surface of the second aluminum workpiece providing the bottom surface of the workpiece stack-up, and wherein the workpiece stack-up comprises a third aluminum workpiece situated between the first and second aluminum workpieces, the third aluminum workpiece having opposed faying surfaces, one of which overlaps and confronts the first faying surface of the first aluminum workpiece to establish a first faying interface and the other of which overlaps and confronts the second faying surface of the second aluminum workpiece to establish a second faying interface.

4. The method set forth in claim 1, wherein each of the aluminum workpieces in the workpiece stack-up is covered with a protective anti-corrosion coating.

5. The method set forth in claim 1, wherein the protective anti-corrosion coating is a refractory oxide coating.

6. The method set forth in claim 1, wherein advancing the laser beam is performed by a scanning optic laser head having tiltable scanning mirrors whose movements are coordinated to move the laser beam relative to the plane of the top surface of the workpiece stack-up.

7. The method set forth in claim 6, wherein the laser beam is a solid-state fiber laser beam or a solid state disk laser beam.

8. The method set forth in claim 1, wherein the one or more nonlinear inner weld paths comprises a spiral inner weld path that revolves around and expands radially outwardly from a fixed interior point.

9. The method set forth in claim 8, wherein the spiral inner weld path is an Archimedean spiral weld path.

10. The method set forth in claim 1, wherein the one or more nonlinear inner weld paths comprises a plurality of radially-spaced and unconnected circular or elliptical inner weld paths that are concentrically arranged about a central point.

11. The method set forth in claim 1, wherein the outer peripheral weld path is interconnected to the one or more nonlinear inner weld paths.

12. The method set forth in claim 1, wherein the keyhole and the surrounding molten aluminum weld pool penetrate into the workpiece stack-up far enough that they intersect each faying interface within the stack-up, but do not reach the bottom surface, during advancement of the laser beam along the outer peripheral weld path in order to provide the weld joint with resolidified composite aluminum workpiece material that fusion welds the overlapping aluminum workpieces in the workpiece stack-up together.

13. The method set forth in claim 1, wherein the one or more nonlinear inner weld paths include weld paths or weld path portions that are radially spaced apart, and wherein advancing the laser beam relative to the plane of the top surface of the workpiece stack-up and along the spot weld travel pattern comprises (1) advancing the laser beam first along the outer peripheral weld path followed by (2) advancing the laser beam along the one or more nonlinear inner weld paths in an radially inward direction.

14. The method set forth in claim 1, further comprising:
remelting a peripheral portion of the weld joint with the laser beam after the laser beam has been advanced along the spot weld travel pattern, the peripheral portion of the weld joint being within an annular edge region of the weld joint that extends from a circumferential edge of the weld joint to an inner circumferential boundary having a radius of seventy percent of a radius of the weld joint, and wherein the peripheral portion that is remelted by the laser beam is disposed around at least 60% of a circumference of the weld joint.

15. A method of remote laser welding a workpiece stack-up that includes at least two overlapping aluminum workpieces, the method comprising:
providing a workpiece stack-up that includes overlapping aluminum workpieces, the workpiece stack-up comprising at least a first aluminum workpiece and a second aluminum workpiece, the first aluminum workpiece providing a top surface of the workpiece stack-up and the second aluminum workpiece providing a bottom surface of the workpiece stack-up, wherein a faying interface is established between each pair of adjacent overlapping aluminum workpieces within the workpiece stack-up, and wherein at least one of the aluminum workpieces in the workpiece stack-up includes a protective anti-corrosion coating;
operating a scanning optic laser head to direct a solid-state laser beam at the top surface of the workpiece stack-up to create a molten aluminum weld pool that penetrates into the workpiece stack-up from the top surface towards the bottom surface and to further produce keyhole located within the molten aluminum weld pool, the solid-state laser beam having a focal length between 0.4 meters and 1.5 meters; and
coordinating the movement of tiltable scanning mirrors within the scanning optic laser head to advance the laser beam relative to a plane of the top surface of the workpiece stack-up and along a spot weld travel pattern so as to translate the keyhole and the surrounding molten aluminum weld pool along a corresponding route relative to the top surface of the workpiece stack-up, the spot weld travel pattern including one or more nonlinear inner weld paths and an outer peripheral weld path that surrounds the one or more nonlinear inner weld paths, and wherein, when the laser beam is advanced along at least the nonlinear inner weld paths, the keyhole and the surrounding molten aluminum weld pool partially penetrate into the workpiece stack-up far enough that they intersect each faying interface within the stack-up in order to provide resolidified composite aluminum workpiece material that fusion welds the overlapping aluminum workpieces in the workpiece stack-up together as part of a weld joint.

16. The method set forth in claim 15, wherein the workpiece stack-up includes only the first and second aluminum workpieces, or wherein the workpiece stack-up further includes a third aluminum workpiece disposed between the first and second aluminum workpieces.

17. The method set forth in claim 15, wherein the one or more nonlinear inner weld paths comprises a spiral inner weld path that revolves around and expands radially outwardly from a fixed interior point.

18. The method set forth in claim 15, wherein the one or more nonlinear inner weld paths comprises a plurality of radially-spaced and unconnected circular or elliptical inner weld paths that are concentrically arranged about a central point.

19. The method set forth in claim 15, wherein the one or more nonlinear inner weld paths include weld paths or weld path portions that are radially spaced apart, and wherein advancing the laser beam relative to the plane of the top surface of the workpiece stack-up and along the spot weld travel pattern comprises (1) advancing the laser beam first along the outer peripheral weld path followed by (2) advancing the laser beam along the one or more nonlinear inner weld paths in an radially inward direction.

20. The method set forth in claim 15, further comprising:
remelting a peripheral portion of the weld joint with the laser beam after the laser beam has been advanced along the spot weld travel pattern, the peripheral portion of the weld joint being within an annular edge region of the weld joint that extends from a circumferential edge of the weld joint to an inner circumferential boundary having a radius of seventy percent of a radius of the weld joint.
